(19) United States
(12) Patent Application Publication
(10) Pub. No.: US 2017/0164403 A1
(43) Pub. Date: Jun. 8, 2017

(54) Controlling Access to a Shared Wireless Medium in a Wireless Communication System

(71) Applicant: TELEFONAKTIEBOLAGET LM ERICSSON (PUBL), Stockholm (SE)

(72) Inventors: Christofer Lindheimer, Linköping (SE); Johan Söder, Stockholm (SE); Leif Wilhelmsson, Dalby (SE)

(21) Appl. No.: 14/913,662

(22) PCT Filed: Jan. 15, 2016
(86) PCT No.: PCT/SE2016/050017

§ 371 Date: Feb. 22, 2016

Related U.S. Application Data
(60) Provisional application No. 62/194,735, filed on Jul. 20, 2015.

(51) Int. Cl. H04W 74/04; H04L 29/08; H04W 74/08

(52) U.S. Cl. CPC H04W 74/04; H04W 74/0816; H04W 74/0825; H04W 74/085; H04L 29/08576

(57) ABSTRACT

There is provided a method of controlling access to a shared wireless medium in a first wireless communication system based on a contention-based protocol for medium access involving carrier sensing, wherein the first wireless communication system is of a first radio access technology. The method comprises determining (S1) whether a second wireless communication system of a second, different radio access technology is operating on the same channel of the shared wireless medium as the first wireless communication system. The method also comprises initiating (S2), if the second wireless communication system is operating on the same channel, a change of a carrier-sensing threshold used in the first wireless communication system for determining, for at least one communication unit, whether the medium is available for access from a first level to a second, different level.

### TECHNICAL FIELD

The proposed technology generally relates to wireless communication technology, and more specifically methods and arrangements for controlling access to a shared wireless medium based on a contention-based protocol for medium access involving carrier sensing, and corresponding communication units, computer programs and computer-program products and apparatuses.

### BACKGROUND

In general, medium access is of outmost importance for the operation and performance of communication networks.

A contention-based protocol is a communication protocol for medium access and for operating communication equipment that allows many users to use the same transmission medium such as a radio medium with little or no pre-coordination.

Carrier Sensing, CS, and Listen Before Talk, LBT, are examples of contention-based procedures for medium access used in wireless communications whereby a radio transmitter first senses its radio environment, i.e. the shared wireless medium or (radio) channel, before it starts a transmission. Sometimes Listen Before Talk is referred to as Sense Before Transmit. The LBT operating procedure in IEEE 802.11 for Wireless Local Area Networks, WLANs, is one of the most well-known contention-based protocols.

For example, Carrier Sensing Multiple Access, CSMA, is a Medium Access Control, MAC, protocol in which a node verifies the absence of other traffic before transmitting on a shared transmission medium, such as an electrical bus, or a band of the electromagnetic spectrum.

Carrier Sensing generally means that a transmitter uses feedback from a receiver to determine whether another transmission is in progress before initiating a transmission. That is, the transmitter tries to detect the presence of a transmission or carrier wave from another station before attempting to transmit. If a transmission/carrier is sensed, the station waits for the transmission in progress to finish before initiating its own transmission. Multiple access means that multiple stations send and/or receive on the medium.

FIG. 1 is a schematic diagram illustrating an example of a wireless network employing carrier sensing with a so-called Clear Channel Assessment Threshold, CCAT. Each access point, AP, normally has a CCAT and a corresponding sensing area. Sensing area can here be understood as the area in which a transmission will be declared as present. The CCAT is used by the AP when performing carrier sensing for transmissions to any of the portable terminals, commonly referred to as stations, STAs, associated to the AP. Similarly, each STA normally also has a CCAT for carrier sensing for transmissions to the AP.

However, wireless networks using carrier sensing as a basis for medium access typically suffer from low spectral efficiency and/or low spatial reuse in dense deployments. This is due to the fact that STAs and APs must defer from accessing the wireless medium if they sense that the medium is busy. To increase the spatial reuse, the medium sensing thresholds may be tuned to be more aggressive. However, this may lead to high interference situations, leading to reduced system performance and impaired user experience.

It has also been recognized that traditional contention-based protocols for medium access suffers from various problems, e.g. relating to unbalanced and/or unfair medium or channel sharing between different communication stations and/or different types of communication systems.

In particular, different types of communication systems may use different strategies and/or thresholds for medium access, which may lead to such an unbalanced and/or unfair medium or channel sharing.

### SUMMARY

It is an object to provide an efficient way of controlling access to a shared wireless medium. By way of example, it is desirable to improve the coexistence of different types of wireless communication systems, especially when operating in unlicensed spectrum.

It is a specific object to provide a method of controlling access to a shared wireless medium.

It is also an object to provide an arrangement configured to control access to a shared wireless medium.

Another object is to provide a communication unit comprising such an arrangement.

Yet another object is to provide a computer program for controlling, when executed by at least one processor, access to a shared wireless medium.

Still another is to provide a computer-program product comprising a computer-readable medium having stored thereon such a computer program.

It is also an object to provide an apparatus for controlling access to a shared wireless medium.

These and other objects are met by embodiments of the proposed technology.

According to a first aspect, there is provided a method of controlling access to a shared wireless medium in a first wireless communication system based on a contention-based protocol for medium access involving carrier sensing, wherein the first wireless communication system is of a first radio access technology. The method comprises:
determining whether a second wireless communication system of a second, different radio access technology is operating on the same channel of the shared wireless medium as the first wireless communication system; and
initiating, if the second wireless communication system is operating on the same channel, a change of a carrier-sensing threshold used in the first wireless communication system for determining, for at least one communication unit, whether the medium is available for access from a first level to a second, different level.

According to another aspect, there is provided an arrangement configured to control access to a shared wireless medium in a first wireless communication system based on a contention-based protocol for medium access involving carrier sensing, wherein the first wireless communication system is of a first radio access technology. The arrangement is configured to determine whether a second wireless communication system of a second, different radio access technology is operating on the same channel of the shared wireless medium as the first wireless communication system. The arrangement is also configured to initiate, if the second wireless communication system is operating on the same channel, a change of a carrier-sensing threshold used in the first wireless communication system for determining, for at least one communication unit, whether the medium is available for access from a first level to a second, different level.

According to yet another aspect, there is provided a communication unit comprising an arrangement as described herein.

According to still another aspect, there is provided a computer program for controlling, when executed by at least one processor, access to a shared wireless medium in a first wireless communication system based on a contention-based protocol for medium access involving carrier sensing, wherein the first wireless communication system is of a first radio access technology. The computer program comprises instructions, which when executed, cause the at least one processor to:
determine whether a second wireless communication system of a second, different radio access technology is operating on the same channel of the shared wireless medium as the first wireless communication system; and
initiate, if the second wireless communication system is operating on the same channel, a change of a carrier-sensing threshold used in the first wireless communication system for determining, for at least one communication unit, whether the medium is available for access from a first level to a second, different level.

According to another aspect, there is provided a computer-program product comprising a computer-readable medium having stored thereon a computer program as defined herein.

According to yet another aspect, there is provided an apparatus for controlling access to a shared wireless medium in a first wireless communication system based on a contention-based protocol for medium access involving carrier sensing, wherein the first wireless communication system is of a first radio access technology. The apparatus comprises:
a determining module for determining whether a second wireless communication system of a second, different radio access technology is operating on the same channel of the shared wireless medium as the first wireless communication system; and
a control module for initiating, if the second wireless communication system is operating on the same channel, a change of a carrier-sensing threshold used in the first wireless communication system for determining, for at least one communication unit, whether the medium is available for access from a first level to a second, different level.

An advantage of the proposed technology is a more efficient strategy for controlling access to a shared wireless medium and especially a more fair and/or balanced medium or channel sharing between different communication stations and/or different types of wireless communication systems.

Other advantages will be appreciated when reading the detailed description.

### BRIEF DESCRIPTION OF THE DRAWINGS

The embodiments, together with further objects and advantages thereof, may best be understood by making reference to the following description taken together with the accompanying drawings, in which:

FIG. 1 is a schematic diagram illustrating an example of a wireless network employing carrier sensing with a common Clear Channel Assessment Threshold, CCAT.

FIG. 2 is a schematic flow diagram illustrating an example of a method of controlling access to a shared wireless medium according to an embodiment.

FIG. 3 is a schematic flow diagram illustrating an example of a method for carrier sensing in a wireless communication system according to an embodiment.

FIG. 4 is a schematic diagram illustrating an example of two WLAN access points taking turn in accessing a radio communication channel.

FIG. 5 is a schematic diagram illustrating an example of two WLAN access points and a base station or similar network node of another type of wireless communication system competing for access to a radio communication channel.

FIG. 6 is a schematic block diagram illustrating an example of an arrangement according to an embodiment.

FIG. 7 is a schematic diagram illustrating an example of a communication unit comprising an arrangement of FIG. 6.

FIG. 8 is a schematic diagram illustrating an example of a computer implementation according to an embodiment.

FIG. 9 is a schematic diagram illustrating an example of an apparatus for controlling access to a shared wireless medium in a wireless communication system according to an embodiment.

FIG. 10 is a schematic diagram illustrating an example of an apparatus for threshold assignment for carrier sensing in a wireless communication system according to an embodiment.

FIG. 11A is a schematic diagram illustrating an example of communication units of different types of communication systems using different strategies and/or thresholds for medium access.

FIG. 11B is a schematic diagram illustrating an example of the received signal level originating from an access point and the relation to a COAT threshold and energy detect threshold.

### DETAILED DESCRIPTION

Throughout the drawings, the same reference designations are used for similar or corresponding elements.

As used herein, the non-limiting term “network node” may refer to an access point or similar radio network node including also access controllers and the like.

As used herein, the non-limiting terms “wireless communication device” and “wireless device” may refer to a terminal or station, STA, User Equipment, UE, a mobile phone, a cellular phone, a Personal Digital Assistant, PDA, equipped with radio communication capabilities, a smart phone, a laptop or Personal Computer, PC, equipped with an internal or external mobile broadband modem, a tablet PC with radio communication capabilities, a target device, a device to device UE, a machine type UE or UE capable of machine to machine communication, iPad, customer premises equipment, CPE, laptop embedded equipment, LEE, laptop mounted equipment, LME, USB dongle, a portable electronic radio communication device, a sensor device equipped with radio communication capabilities or the like. In particular, the term “wireless device” should be interpreted as a non-limiting term comprising any type of wireless device communicating with a radio network node in a wireless communication system or any device equipped with radio circuitry for wireless communication according to any relevant standard for wireless communication.

In the following, the general non-limiting term “communication unit” includes network nodes and/or associated wireless devices.

For a better understanding it may be useful to begin with a brief overview and problem analysis.

As mentioned, different types of communication systems may use different strategies and/or thresholds for medium access, which may lead to unbalanced and/or unfair medium or channel sharing.

For example, cellular radio access technologies such as License Assisted Access, LAA, or Long Term Evolution Unlicensed, LTE-U, are being introduced in the unlicensed spectrum such as the 5 GHz band and will co-exist together with other wireless networks such as WLANs, e.g. Wi-Fi. LAA is a technology for aggregated access to licensed and unlicensed spectrum, and allows operators to benefit from the additional capacity available in the unlicensed part of the spectrum.

Wi-Fi uses a carrier sensing mechanism to assess if the channel is busy prior to transmission. If the channel is sensed as busy, Wi-Fi will defer transmissions and sense again.

The same principles are being discussed for LAA, and there is currently an ongoing discussion how these mechanisms should work.

To assess if the medium or channel is busy, Wi-Fi uses a Clear Channel Assessment Threshold, CCAT, for which, if a received Wi-Fi signal is stronger than this level, the channel is perceived as occupied. If the signal is not stronger than this threshold, the channel is perceived as idle, and it is OK to transmit. This procedure is denoted signal detection (also referred to as pre-amble detection). Signal detection is conditioned on the possibility to actually identify a Wi-Fi signal, i.e., actually decode parts of a packet. If it is not possible to decode a Wi-Fi signal, a procedure referred to as energy detection is used instead. In energy detection the received energy level is measured and compared to another threshold, the energy detect threshold, which is 20 dB higher than the COAT.

LAA also uses a threshold, but does not attempt to t detect any Wi-Fi signal. It simply use the energy detect threshold, i.e., the same higher threshold for when “any energy” is detected, to assess if the channel is busy.

The inventors have recognized that in some scenarios it may be detrimental to Wi-Fi if it uses a different threshold than LAA or LTE-unlicensed for assessing when a channel is available.

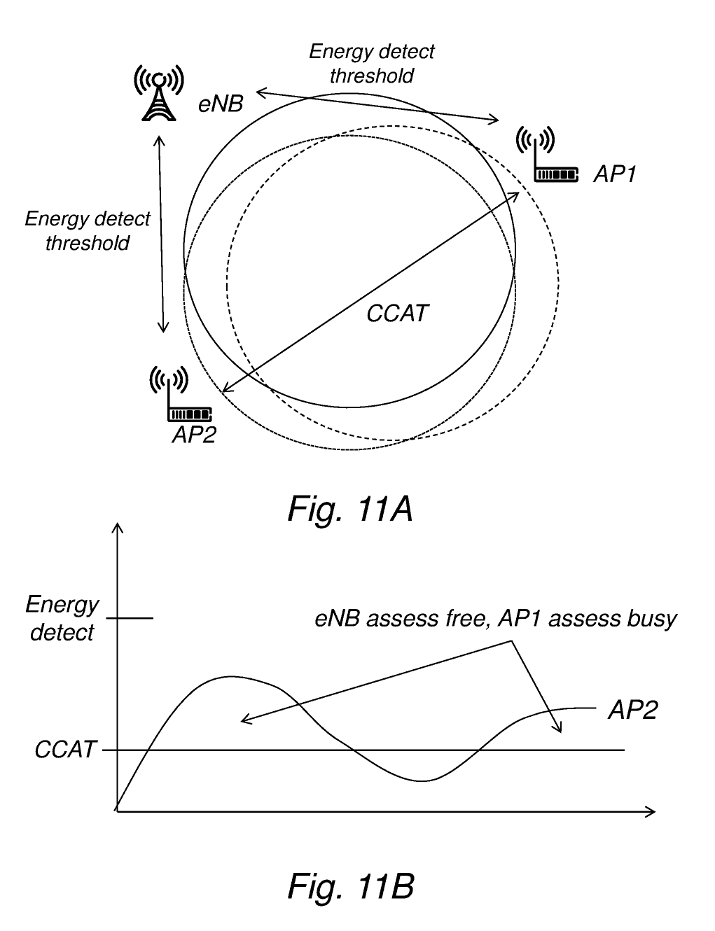

FIG. 11A is a schematic diagram illustrating an example of communication units of different types of communication systems using different strategies and/or thresholds for medium access. In this example, Wi-Fi access points AP1 and AP2 employ a COAT threshold to assess if the medium or channel is busy. A co-existing eNB on the other hand may simply use the energy detect threshold to assess if the channel is busy.

This may render that, everything else equal, LAA or LTE-unlicensed users may obtain much more transmission opportunities than any Wi-Fi user, whether STA or AP.

FIG. 11B is a schematic diagram illustrating an example of the received signal level originating from an access point, AP2, and the relation to a COAT threshold and energy detect threshold. Assuming the same or similar signal level is received by eNB and AP1, the eNB may assess the medium as free while AP1 will assess the medium as busy because the eNB uses the higher energy detect threshold and AP1 uses the lower COAT threshold.

Specifically, two or more Wi-Fi networks using the same channel may thus not be able operate simultaneously due to that the COAT is set to −82 dBm, whereas if LAA or LTE-unlicensed is operating in the same channel this may be able to work concurrently with the Wi-Fi networks. Effectively this means that in deployments where there are already Wi-Fi networks, it may be the case that Wi-Fi has a slight disadvantage compared to LAA or LTE-unlicensed when doing network densification.

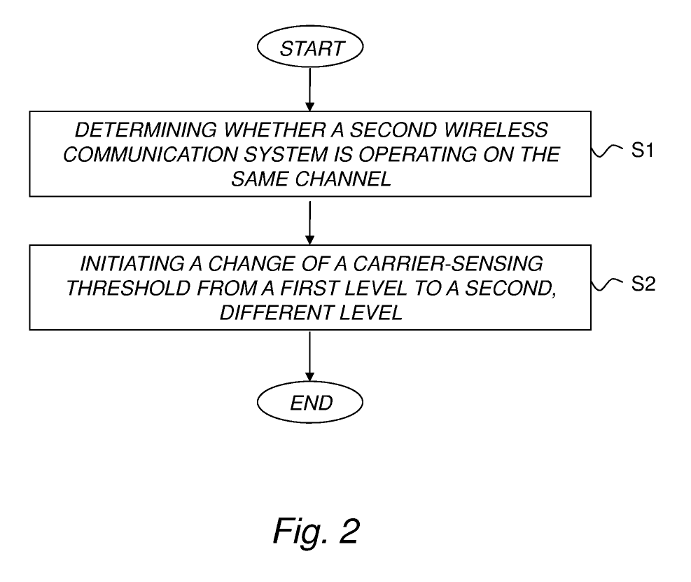

FIG. 2 is a schematic flow diagram illustrating an example of a method of controlling access to a shared wireless medium according to an embodiment.

According to a first aspect, there is provided a method of controlling access to a shared wireless medium in a first wireless communication system based on a contention-based protocol for medium access involving carrier sensing, wherein the first wireless communication system is of a first radio access technology. The method comprises:
S1: determining whether a second wireless communication system of a second, different radio access technology is operating on the same channel of the shared wireless medium as the first wireless communication system; and
S2: initiating, if the second wireless communication system is operating on the same channel, a change of a carrier-sensing threshold used in the first wireless communication system for determining, for at least one communication unit, whether the medium is available for access from a first level to a second, different level.

In this way, a more fair and/or balanced medium or channel sharing between different communication stations and/or different types of communication systems may be obtained.

By way of example, the carrier-sensing threshold used in the first wireless communication system for determining, for at least one communication unit, whether the medium is available for access is increased from a first lower level to a second higher level.

As a possible add-on, the first threshold level may be used for carrier-sensing applicable for transmissions originating from the same service set, whereas the second threshold level may be used for carrier-sensing applicable for transmissions originating from other service sets within the first wireless communication system. The second threshold level may thus be used for carrier-sensing for transmissions originating from other service sets under the condition that it has been determined that the second wireless communication system is operating on the same channel of the shared wireless medium as the first wireless communication system.

For example, the carrier-sensing threshold used in the first wireless communication system for determining, for at least one communication unit, whether the medium is available for access may be aligned to a so-called co-existence threshold level which differs from a default carrier-sensing threshold level used for signal detection within the first wireless communication system.

In a particular example, the default carrier-sensing threshold level is nevertheless maintained for carrier-sensing applicable for transmissions originating from within the same service set.

A service set is normally considered as a set of communication units or devices associated with a wireless network, and especially a WLAN type network. In particular, a Basic Service Set, BSS, provides the basic building block of a WLAN such as 802.11 type wireless network. In infrastructure mode, an access point together with associated stations, STAs, is called a BSS. Alternatively, it is possible to set up an ad hoc network of client stations without a controlling access point, the result is normally called and Independent Basic Service Set, IBSS. An Extended Service Set, ESS, is a set of two or more interconnected BSSs that share the same Service Set Identification, SSID.

In a particular embodiment, a first carrier-sensing threshold is assigned for use in the first wireless communication system, applicable for transmissions identified as originating from within the same service set as the carrier-sensing communication unit. A second carrier-sensing threshold is assigned for use in the first wireless communication system, applicable for transmissions identified as originating from outside the service set of the carrier-sensing communication unit, wherein the second carrier-sensing threshold is aligned or changed to the second level.

Typically, the co-existence threshold level corresponds to a situation of co-existence of transmissions of the first wireless communication system and the second wireless communication system on the same channel.

As an example, the co-existence threshold level is higher than the default carrier-sensing threshold level.

In a particular embodiment, the co-existence level corresponds to the level of a threshold used in the second wireless communication system for determining whether the medium is available for access.

By way of example, the co-existence level may correspond to the level used in the first wireless communication system for determining whether the medium is available for access when no carrier is detected.

The co-existence level may correspond to the level used in the first wireless communication system for energy detection.

As an example, the carrier-sensing threshold is a threshold for detection of signals within the first wireless communication system. This may involve at least partially decoding and/or otherwise recognizing a certain type of signals, e.g. WLAN or Wi-Fi signals.

The carrier-sensing threshold may be a Clear Channel Assessment Threshold, CCAT.

In a particular embodiment, the step of determining whether a second wireless communication system of a second, different type or radio access technology is operating on the same channel of the shared wireless medium as the first wireless communication system includes identifying ongoing or recent transmissions in the second wireless communication system on the considered channel.

By way of example, the first wireless communication system may be a Wireless Local Area Network, WLAN, system and the second wireless communication system may be a cellular radio network operating in unlicensed spectrum.

For example, the first wireless communication system may be a Wi-Fi system.

For example, the second wireless communication system may be based on License Assisted Access, LAA, or Long Term Evolution, LTE, unlicensed.

The method may for example be performed by a communication unit such as an access point or wireless communication device of the first wireless communication system.

By way of example, an access point may initiate the change of the carrier-sensing threshold by informing at least one associated wireless communication device that the carrier-sensing threshold should be changed from the first level to the second level. For example, an access point may inform the associated STAs of its BSS of the change of carrier-sensing threshold through an information bit or information field in the beacon broadcast transmission. As another example an access point may inform each associated STAs of the same BSS by means of unicast information of a dedicated signaling message. As yet another example an access point may inform associated STAs of the same BSS by setting an information bit of a header when data is transmitted (DL or UL) between the access point and the station. If data is transmitted in the UL direction, the information may be conveyed in the ACK frame sent by the access point. If the data is transmitted in the DL direction, the information may be conveyed in the PHY or MAC header of the data transmission.

Alternatively, a wireless communication device may identify that the second wireless communication system is operating on the same channel as the first wireless communication system and initiate the change of the carrier-sensing threshold.

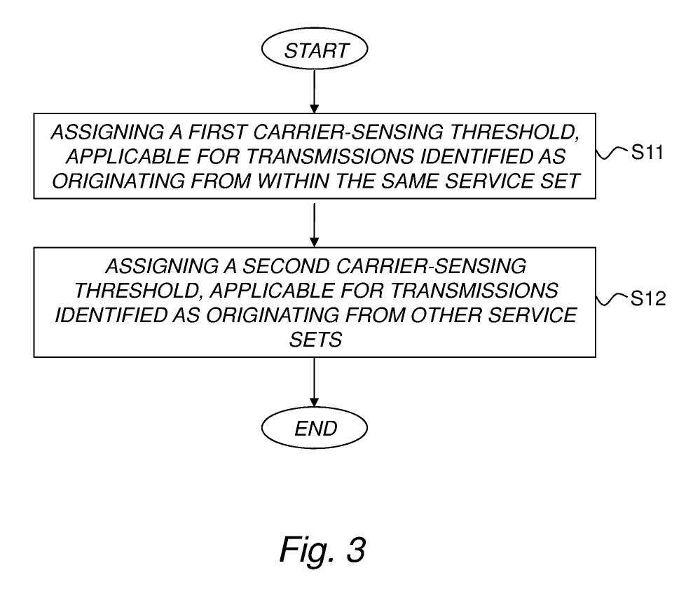

FIG. 3 is a schematic flow diagram illustrating an example of a method for carrier sensing in a wireless communication system according to an embodiment. This method could possibly be used independently, but is preferably used as an add-on to the previously described method according to the first aspect, when another system of a different radio access technology has been detected.

There is thus provided a method for carrier sensing by a communication unit in a first wireless communication system, wherein the communication unit belongs to a service set.

The method comprises:
S11: assigning a first carrier-sensing threshold for use in the first wireless communication system, applicable for transmissions identified as originating from within the same service set; and
S12: assigning a second carrier-sensing threshold for use in the first wireless communication system, applicable for transmissions identified as originating from other service sets,
   wherein the first carrier-sensing threshold and the second carrier-sensing threshold are different.

In other words, for carrier-sensing by a particular communication unit such as an access point or an associated wireless communication device, there is a distinction between transmissions identified as originating from within the same service set as the considered communication unit and transmissions identified as originating from other service sets.

In particular, this means that the first carrier-sensing threshold may be applied when detecting signals to/from communication units within the service set to which the carrier-sensing communication unit belongs, whereas the second carrier-sensing threshold may be applied when detecting signals originating from outside of the service set to which the carrier-sensing communication unit belongs.

In other words, the proposed technology may thus, for example, use the first carrier-sensing threshold for carrier sensing with respect to transmissions identified as originating from within a specific I/BSS and/or ESS, while using the second carrier-sensing threshold for carrier sensing with respect to transmissions identified as originating from other I/BSS:s and/or other ESS:s.

By way of example, the second carrier-sensing threshold is set to a higher level than the first carrier-sensing threshold.

For example, the second carrier-sensing threshold may be aligned to a level used in the first wireless communication system for energy detection.

As an example, the second carrier-sensing threshold may be aligned to a level of a threshold used in a second, different wireless communication system for determining whether the medium is available for access.

In a particular embodiment, the second wireless communication system is of a different type or radio access technology than the first wireless communication system.

By way of example, the first wireless communication system may be a Wireless Local Area Network, WLAN, system and the second wireless communication system may be a cellular radio network operating in unlicensed spectrum.

For example, the first wireless communication system may be a Wi-Fi system.

For example, the second wireless communication system may be based on License Assisted Access, LAA, or Long Term Evolution, LTE, unlicensed.

The method may for example be performed by a communication unit such as an access point or wireless communication device of the first wireless communication system.

The proposed technology may also be regarded as a technology for improving the coexistence between different types of wireless communication systems operating in unlicensed spectrum.

It should also be understood that the proposed technology may be applied on the network side and/or the terminal side.

The proposed technology may be used separately, or combined and/or integrated with any conventional mechanism involving normal carrier sensing thresholds.

For a better understanding of the proposed technology, it may be useful with a brief overview and analysis with reference to the particular non-limiting context of a Wireless Local Area Network, WLAN.

The WLAN technology is a general technology for local wireless communications. As the name implies Wireless Local Area Network, WLAN, technology offers a basis for wireless communications within a local area coverage. The WLAN technology includes industry-specific solutions as well as proprietary protocols, although most commercial applications are based on well-accepted standards such as the various versions of IEEE 802.11, also popularly referred to as Wi-Fi.

WLAN is standardized in the IEEE 802.11 specifications such as IEEE Standard for Information technology—Tele-communications and information exchange between systems. Local and metropolitan area networks—Specific requirements. Part 11: Wireless LAN Medium Access Control (MAC) and Physical Layer (PHY) Specifications). WLAN systems following the 802.11 MAC specifications operate based on distributed medium or channel access, meaning that each node in the network has more or less equal probability of accessing the medium.

WLAN or Wi-Fi currently mainly operates on the 2.4 GHz or the 5 GHz band. The IEEE 802.11 specifications regulate the access points' or wireless terminals' physical layer, MAC layer, and other aspects to secure compatibility and inter-operability between access points, also referred to as APs, and wireless devices or terminals, also referred to as STAs. Wi-Fi is generally operated in unlicensed bands, and as such, communication over Wi-Fi may be subject to interference sources from any number of both known and unknown devices. Wi-Fi is commonly used as wireless extensions to fixed broadband access, e.g., in domestic environments and hotspots, like airports, train stations and restaurants.

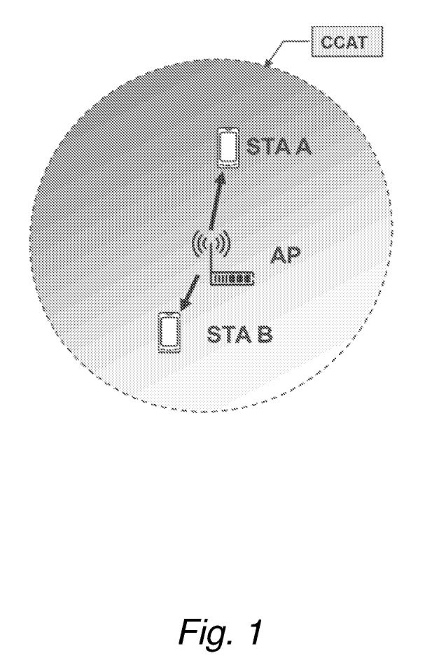

The WLAN technology relies on Carrier Sensing Multiple Access with Collision Avoidance, CSMA/CA, in order to effectively and fairly share the wireless medium among different WLAN entities and even different Radio Access Technologies, RATs. CSMA/CA applied by the WLAN system demands that every device that wishes to send data senses the common communication channel or medium before carrying out a transmission in order to avoid duplicate transmissions that usually would result in loss of data and need of retransmissions. In order for a device to deem the channel busy, it has to detect a transmission, the received signal strength level of which surpasses a pre-determined threshold, referred to as a CCAT threshold, as previously described in connection with FIG. 1.

With static CCAT, a node may refrain from accessing the medium since it is exposed to concurrent transmissions in neighboring Basic Serving Set, BSSs, although simultaneous or concurrent communication would be possible. This limits the performance of current systems, especially as the CCA threshold used today is very low, −82 dBm. If STAs and APs could dynamically adapt their carrier sensing threshold then the amount of concurrent transmissions in the system may be increased without increasing the probability of collisions within the BSS. This would mean an increase in spectral efficiency of the system.

In a particular non-limiting example, it is proposed that Wi-Fi nodes identify or detect if there is another wireless system present in the same channel, e.g. an LTE-LAA system. If there are ongoing LAA transmissions the access point, AP, may for example broadcast to the STA's in the BSS that the COAT should be set to the same level as the Energy Detect, ED, threshold normally used for transmissions outside its own BSS. For transmissions within the same BSS, e.g., if it is identified that a transmission originates from a user communicating within own BSS, the channel could preferably be considered as being busy to avoid collisions. In this particular way, the channel will be shared with LAA in a way that does not give LAA a large advantage.

Using the above-described method, Wi-Fi and LAA may compete for transmission opportunities using the same definition of when a channel is perceived as occupied. Within a BSS, it may be more important to protect own traffic and thus, there may be no gain using the same thresholds as for Energy Detect.

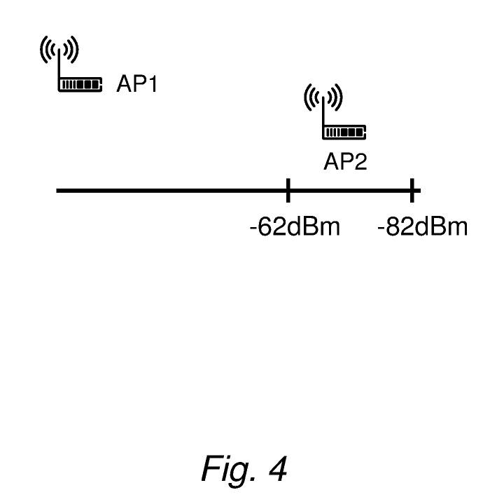

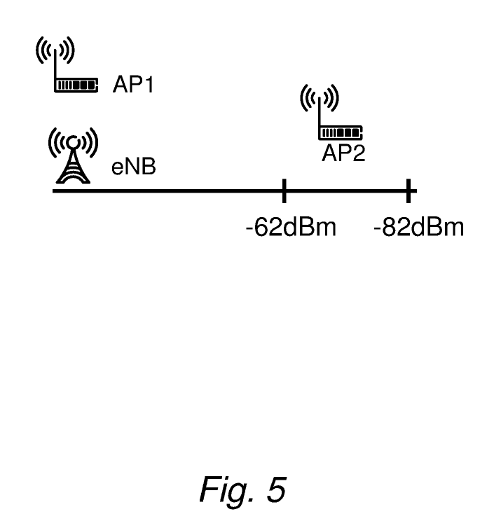

The above-described problem is best illustrated using three different “entities” or access points using the same channel; AP1 and AP2 and LAA, for example referring to FIG. 4 and FIG. 5. For the purpose of description, we assume that AP1 and AP2 are not part of the same Extended/Basic Service Set, E/BSS. For example, AP1 and AP2 are part of BSS1 and BSS2, respectively.

If AP 1 uses a first threshold level −82 dBm towards AP2 and LAA uses a second threshold level −62 dBm towards AP2, LAA will perceive transmission opportunities when AP1 perceive channel busy.

If AP2 uses −82 dBm towards AP1 and LAA use −62 dBm towards AP1, LAA will perceive transmission opportunities when AP2 perceive channel busy.

To make the situation more equal in terms of assessing if the channel is actually busy or not, it would be beneficial to use the same threshold.

First, consider the situation in FIG. 4, where AP1 and AP2 are taking turns in accessing the channel. In FIG. 5, a base station such as an LAA eNodeB, eNB, is added. The eNB will not defer for AP2, but rather transmit concurrently. The AP1 may be disadvantaged since it will time-share the channel with both the eNB and AP2. What may be in particular problematic is that AP1 will only find the channel idle if both AP2 and the eNB are not transmitting. Since the eNB will not defer from AP2, it is easy to see that AP2 can be almost starved. Suppose the load in BSS2 corresponding to AP2 is 75%. Furthermore, suppose that the load in LAA is also 50%. If BSS2 and LAA are assumed to be independent of one another, the probability that the channel is found to be idle is (1−¾)*½=12.5%. For some applications this will not be sufficient.

In a particular example, it is suggested that AP1 should, upon detection of the presence of the eNB, change its COAT to the second threshold level, such as the ED level (−62 dBm), and hence transmit concurrently with AP2. In this way the channel is shared in a fair way with the LAA eNB. As the load in this example was 50% for LAA, it will leave 50% of the channel time for BSS1. Thus LAA will still have 50%, but the channel occupancy for BSS1 has increased from 12.5% to 50%. Essentially, fair sharing has been achieved between LAA and BSS1 at the same time as full spatial reuse is achieved with BSS2.

Examples of how to Identify that a Network Node Using Another Technology is Present

Signal Patterns

If a Wi-Fi node (AP or terminal) finds the medium busy through energy detect more than X % of the time one may suspect that another system is also using the same channel, where X is a configurable value. The Wi-Fi node could then measure the duration of these busy periods—and if the period is constant it may be concluded that a frame based wireless system is also present in the channel.

Explicitly Signaling

If e.g. the Wi-Fi node is co-located with the LAA node, in the network node (AP and eNB) or in the device node, the Wi-Fi node may obtain information about the LAA activity through explicit (node-internal) signaling.

Spectrum Analysis/Estimation

Different signals have different spectral properties which can be used to determine what standards are present. LTE, for instance, has a bandwidth of 18 MHz, whereas 802.11ax is proposed to have a signal bandwidth of more than 19 MHz, both systems operating in a 20 MHz channel. By detecting the bandwidth of the signals, it can thus be determined whether LAA is also operating in the band in addition to Wi-Fi.

Time Correlation

Systems using OFDM uses a cyclic prefix (CP), also referred to as guard interval (GI) to handle delay spread of the channel. As the CP is just a copy of the last part of an OFDM symbol, this can be used to determine the duration of an OFDM symbol. As the lengths of the OFDM symbols are different for LAA and Wi-Fi, this is a simple means to determine what systems are using the channel.

Examples of how to Share the Threshold Change

In case the AP identifies that another wireless system is present in the same channel, the AP may inform the associated STAs through broadcast messages that the COAT should be changed to the level of ED. This may for instance be done in the beacon. However, it may also be done using dedicated signaling to individual STAs.

In case a terminal identifies that another wireless system is present in the same channel it may inform the AP that this is the case, and the AP in turn may broadcast this information, as explained above.

It may also be a fully distributed scheme. For example, since there may be a situation where only some of the STAs are affected by the LAA activities, it may be preferred that the STAs identify this autonomously without involving the AP, and then set the COAT accordingly. This may effectively means that some STAs in a BSS may use the first threshold level and others may use the second threshold level. For example, some STAs may use COAT=−82 dBm, whereas others may use −62 dBm.

It will be appreciated that the methods and devices described herein can be combined and re-arranged in a variety of ways.

For example, embodiments may be implemented in hardware, or in software for execution by suitable processing circuitry, or a combination thereof.

The steps, functions, procedures, modules and/or blocks described herein may be implemented in hardware using any conventional technology, such as discrete circuit or integrated circuit technology, including both general-purpose electronic circuitry and application-specific circuitry.

Particular examples include one or more suitably configured digital signal processors and other known electronic circuits, e.g. discrete logic gates interconnected to perform a specialized function, or Application Specific Integrated Circuits, ASICs.

Alternatively, at least some of the steps, functions, procedures, modules and/or blocks described herein may be implemented in software such as a computer program for execution by suitable processing circuitry such as one or more processors or processing units.

Examples of processing circuitry includes, but is not limited to, one or more microprocessors, one or more Digital Signal Processors, DSPs, one or more Central Processing Units, CPUs, video acceleration hardware, and/or any suitable programmable logic circuitry such as one or more Field Programmable Gate Arrays, FPGAs, or one or more Programmable Logic Controllers, PLCs.

It should also be understood that it may be possible to re-use the general processing capabilities of any conventional device or unit in which the proposed technology is implemented. It may also be possible to re-use existing software, e.g. by reprogramming of the existing software or by adding new software components.

According to another aspect, there is provided an arrangement configured to control access to a shared wireless medium in a first wireless communication system based on a contention-based protocol for medium access involving carrier sensing, wherein the first wireless communication system is of a first radio access technology. The arrangement is configured to determine whether a second wireless communication system of a second, different radio access technology is operating on the same channel of the shared wireless medium as the first wireless communication system. The arrangement is also configured to initiate, if the second wireless communication system is operating on the same channel, a change of a carrier-sensing threshold used in the first wireless communication system for determining, for at least one communication unit, whether the medium is available for access from a first level to a second, different level.

By way of example, the carrier-sensing threshold used in the first wireless communication system for determining, for at least one communication unit, whether the medium is available for access is increased from a first lower level to a second higher level.

For example, the carrier-sensing threshold used in the first wireless communication system for determining, for at least one communication unit, whether the medium is available for access may be aligned to a so-called co-existence threshold level which differs from a default carrier-sensing threshold level used for signal detection within the first wireless communication system.

In a particular example, the default carrier-sensing threshold level is nevertheless maintained for carrier-sensing applicable for transmissions originating from users within the same service set.

Typically, the co-existence threshold level corresponds to a situation of co-existence of transmissions of the first wireless communication system and the second wireless communication system on the same channel.

As an example, the co-existence threshold level is higher than the default carrier-sensing threshold level.

In a particular embodiment, the co-existence level corresponds to the level of a threshold used in the second wireless communication system for determining whether the medium is available for access.

By way of example, the co-existence level may correspond to the level used in the first wireless communication system for determining whether the medium is available for access when no carrier is detected.

The co-existence level may correspond to the level used in the first wireless communication system for energy detection.

As an example, the carrier-sensing threshold is a threshold for detection of signals within the first wireless communication system.

By way of example, the first wireless communication system may be a Wireless Local Area Network, WLAN, system and the second wireless communication system may be a cellular radio network operating in unlicensed spectrum.

For example, the first wireless communication system may be a Wi-Fi system.

For example, the second wireless communication system may be based on License Assisted Access, LAA, or Long Term Evolution, LTE, unlicensed.

There is also provided an arrangement configured for carrier sensing by a communication unit in a first wireless communication system, wherein the communication unit belongs to a service set. The arrangement is configured to assign a first carrier-sensing threshold for use in the first wireless communication system, applicable for transmissions identified as originating from within the same service set. The arrangement is also configured to assign a second carrier-sensing threshold for use in the first wireless communication system, applicable for transmissions identified as originating from other service sets, wherein the first carrier-sensing threshold and the second carrier-sensing threshold are different.

In particular, this means that the first carrier-sensing threshold may be applied when detecting signals to/from communication units within the service set to which the carrier-sensing communication unit belongs, whereas the second carrier-sensing threshold may be applied when detecting signals originating from outside of the service set to which the carrier-sensing communication unit belongs.

By way of example, the second carrier-sensing threshold is set to a higher level than the first carrier-sensing threshold.

For example, the second carrier-sensing threshold may be aligned to a level used in the first wireless communication system for energy detection.

As an example, the second carrier-sensing threshold may be aligned to a level of a threshold used in a second, different wireless communication system for determining whether the medium is available for access.

In a particular embodiment, the second wireless communication system is of a different type or radio access technology than the first wireless communication system.

By way of example, the first wireless communication system may be a Wireless Local Area Network, WLAN, system and the second wireless communication system may be a cellular radio network operating in unlicensed spectrum.

For example, the first wireless communication system may be a Wi-Fi system.

For example, the second wireless communication system may be based on License Assisted Access, LAA, or Long Term Evolution, LTE, unlicensed.

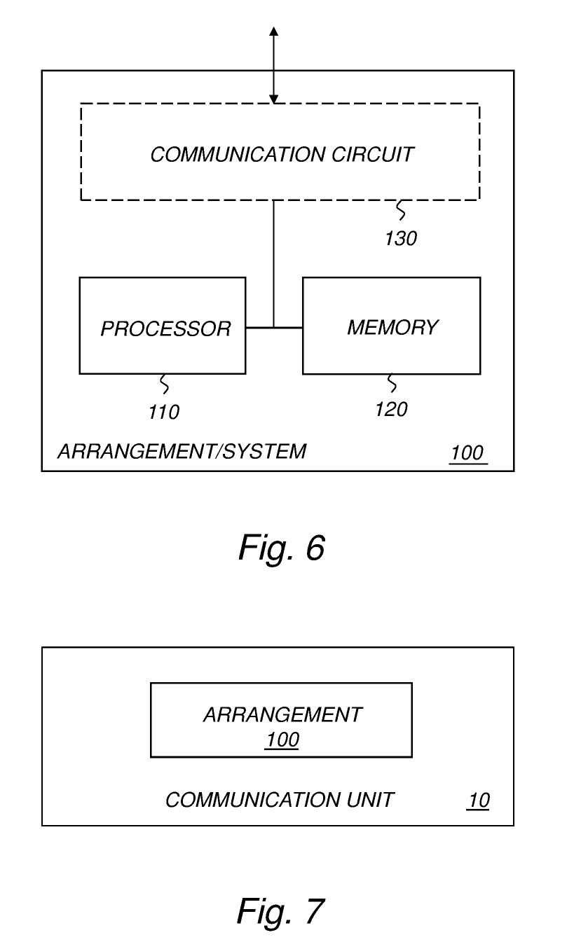

FIG. 6 is a schematic block diagram illustrating an example of an arrangement according to an embodiment. In this particular example, the arrangement 100 comprises a processor 110 and a memory 120, the memory comprising instructions executable by the processor, whereby the arrangement is operative to perform the above functions, steps and/or actions, including to control access to the shared wireless medium, and to enable carrier sensing, respectively.

Optionally, the arrangement 100 may also include a communication circuit 130. The communication circuit may include functions for wired and/or wireless communication with other devices and/or network nodes in the network. In a particular example, the communication circuit may be based on radio circuitry for communication with one or more other nodes, including transmitting and/or receiving information. The communication circuit may be interconnected to the processor and/or memory.

According to yet another aspect, there is provided a communication unit comprising an arrangement as described herein.

FIG. 7 is a schematic diagram illustrating an example of a communication unit comprising the arrangement of FIG. 6. The communication unit 10 basically comprises the arrangement 100. The communication unit 10 may for example be a network node such as an access point, radio network node or access controller, or a wireless communication device.

In case, the arrangement 100 itself does not include any communication circuit for wired and/or wireless communication with other devices and/or network nodes, the arrangement 100 may alternatively use the communication functionality of the communication unit 10 for external communication. In this case, the arrangement 100 is connected to the communication circuit(s) (not shown in FIG. 7) of the communication unit.

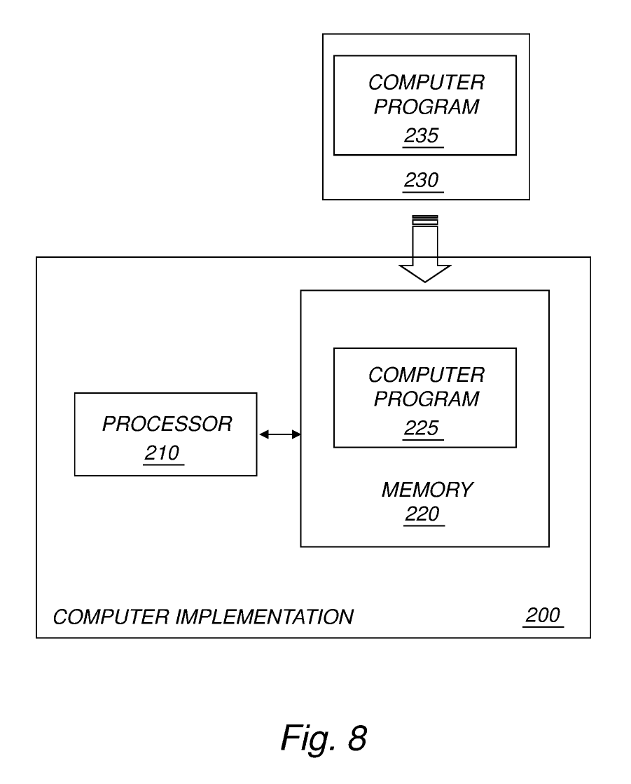

FIG. 8 is a schematic diagram illustrating an example of a computer implementation according to an embodiment.

In this particular example, at least some of the steps, functions, procedures, modules and/or blocks described herein are implemented in a computer program 225; 235, which is loaded into the memory 220 for execution by processing circuitry including one or more processors. The processor(s) 210 and memory 220 are interconnected to each other to enable normal software execution. An optional input/output device may also be interconnected to the processor(s) and/or the memory to enable input and/or output of relevant data such as input parameter(s) and/or resulting output parameter(s).

The term ‘processor’ should be interpreted in a general sense as any system or device capable of executing program code or computer program instructions to perform a particular processing, determining or computing task.

The processing circuitry including one or more processors is thus configured to perform, when executing the computer program, well-defined processing tasks such as those described herein.

The processing circuitry does not have to be dedicated to only execute the above-described steps, functions, procedure and/or blocks, but may also execute other tasks.

According to still another aspect, there is provided a computer program for controlling, when executed by at least one processor, access to a shared wireless medium in a first wireless communication system based on a contention-based protocol for medium access involving carrier sensing, wherein the first wireless communication system is of a first radio access technology. The computer program comprises instructions, which when executed, cause the at least one processor to:
determine whether a second wireless communication system of a second, different radio access technology is operating on the same channel of the shared wireless medium as the first wireless communication system; and
initiate, if the second wireless communication system is operating on the same channel, a change of a carrier-sensing threshold used in the first wireless communication system for determining, for at least one communication unit, whether the medium is available for access from a first level to a second, different level.

There is also provided a computer program for performing, when executed by at least one processor, threshold assignment for carrier sensing in a first wireless communication system. The computer program comprises instructions, which when executed, cause the at least one processor to:
assign a first carrier-sensing threshold for use in the first wireless communication system, applicable for transmissions identified as originating from within the same service set as the communication unit performing the carrier-sensing;
assign a second, different carrier-sensing threshold for use in the first wireless communication system, applicable for transmissions identified as originating from other service sets.

The proposed technology also provides a carrier comprising the computer program, wherein the carrier is one of an electronic signal, an optical signal, an electromagnetic signal, a magnetic signal, an electric signal, a radio signal, a microwave signal, or a computer-readable storage medium.

According to another aspect, there is thus provided a computer-program product comprising a computer-readable medium having stored thereon a computer program as defined herein.

By way of example, the software or computer program 225; 235 may be realized as a computer program product, which is normally carried or stored on a computer-readable medium 220; 230, in particular a non-volatile medium. The computer-readable medium may include one or more removable or non-removable memory devices including, but not limited to a Read-Only Memory, ROM, a Random Access Memory, RAM, a Compact Disc, CD, a Digital Versatile Disc, DVD, a Blu-ray disc, a Universal Serial Bus, USB, memory, a Hard Disk Drive, HDD, storage device, a flash memory, a magnetic tape, or any other conventional memory device. The computer program may thus be loaded into the operating memory of a computer or equivalent processing device for execution by the processing circuitry thereof.

The flow diagram or diagrams presented herein may therefore be regarded as a computer flow diagram or diagrams, when performed by one or more processors. A corresponding apparatus may be defined as a group of function modules, where each step performed by the processor corresponds to a function module. In this case, the function modules are implemented as a computer program running on the processor. Hence, the arrangement may alternatively be defined as a group of function modules, where the function modules are implemented as a computer program running on at least one processor.

The computer program residing in memory may thus be organized as appropriate function modules configured to perform, when executed by the processor, at least part of the steps and/or tasks described herein.

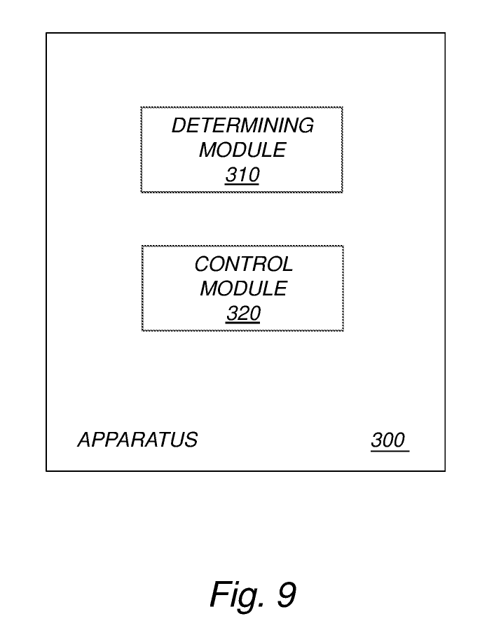

FIG. 9 is a schematic diagram illustrating an example of an apparatus for controlling access to a shared wireless medium in a wireless communication system according to an embodiment.

According to yet another aspect, there is provided an apparatus 300 for controlling access to a shared wireless medium in a first wireless communication system based on a contention-based protocol for medium access involving carrier sensing, wherein the first wireless communication system is of a first radio access technology. The apparatus 300 comprises:
a determining module 310 for determining whether a second wireless communication system of a second, different radio access technology is operating on the same channel of the shared wireless medium as the first wireless communication system; and
a control module 320 for initiating, if the second wireless communication system is operating on the same channel, a change of a carrier-sensing threshold used in the first wireless communication system for determining, for at least one communication unit, whether the medium is available for access from a first level to a second, different level.

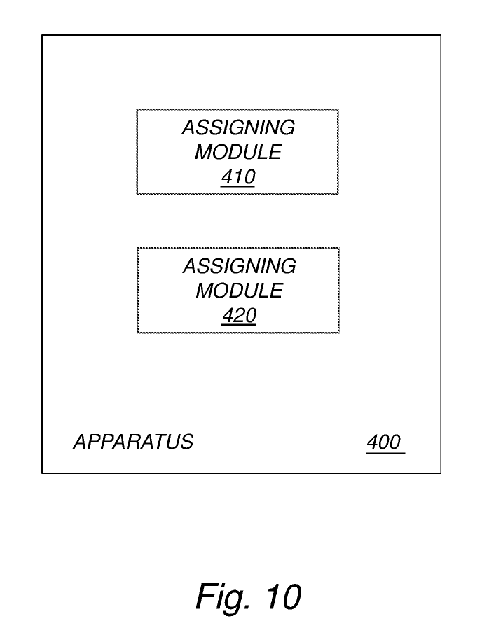

FIG. 10 is a schematic diagram illustrating an example of an apparatus for threshold assignment for carrier sensing in a wireless communication system according to an embodiment.

There is also provided an apparatus for threshold assignment for carrier sensing in a first wireless communication system. The apparatus comprises:
a module 410 for assigning a first carrier-sensing threshold for use in the first wireless communication system, applicable for transmissions identified as originating from within the same service set as the communication unit performing the carrier-sensing; and
a module 420 for assigning a second carrier-sensing threshold for use in the first wireless communication system, applicable for transmissions identified as originating from other service sets,
wherein the first carrier-sensing threshold and the second carrier-sensing threshold are different.

The module 410 and the module 420 may also be referred to as a first assigning module 410 and a second assigning module 420. Alternatively, the module 410 and the module 420 are integrated into a common assigning module.

Alternatively it is possibly to realize the modules in FIG. 9 and FIG. 10, respectively, predominantly by hardware modules, or alternatively by hardware, with suitable interconnections between relevant modules. Particular examples include one or more suitably configured digital signal processors and other known electronic circuits, e.g. discrete logic gates interconnected to perform a specialized function, and/or Application Specific Integrated Circuits, ASICs, as previously mentioned. Other examples of usable hardware include input/output, I/O, circuitry and/or circuitry for receiving and/or sending signals. The extent of software versus hardware is purely an implementation selection.

The embodiments described above are merely given as examples, and it should be understood that the proposed technology is not limited thereto. It will be understood by those skilled in the art that various modifications, combinations and changes may be made to the embodiments without departing from the present scope as defined by the appended claims. In particular, different part solutions in the different embodiments can be combined in other configurations, where technically possible.

1-33. (canceled)

34. A method of controlling access to a shared wireless medium in a first wireless communication system based on a contention-based protocol for medium access involving carrier sensing, wherein the first wireless communication system is of a first radio access technology, the method comprising:
determining whether a second wireless communication system of a second, different, radio access technology is operating on the same channel of the shared wireless medium as the first wireless communication system; and
initiating, in response to determining that the second wireless communication system is operating on the same channel, a change of a carrier-sensing threshold used in the first wireless communication system for determining, for at least one communication unit, whether the medium is available for access, from a first level to a second, different level.

35. The method of claim 34, wherein the carrier-sensing threshold is increased from a first lower level to a second, higher, level.

36. The method of claim 34, wherein the first threshold level is used for carrier-sensing applicable for transmissions originating from the same service set, whereas the second threshold level is used for carrier-sensing applicable for transmissions originating from other service sets within the first wireless communication system.

37. The method of claim 34, wherein the carrier-sensing threshold is aligned to a so-called co-existence threshold level which differs from a default carrier-sensing threshold level used for signal detection within the first wireless communication system.

38. The method of claim 37, wherein the default carrier-sensing threshold level is maintained for carrier-sensing applicable for transmissions originating from within the same service set.

39. The method of claim 37, wherein the co-existence level corresponds to one of:
the level of a threshold used in the second wireless communication system for determining whether the medium is available for access;
the level used in the first wireless communication system for determining whether the medium is available for access when no carrier is detected; and
the level used in the first wireless communication system for energy detection.

40. The method of claim 34, wherein the carrier-sensing threshold is a threshold for detection of signals, involving at least partially decoding and/or otherwise recognizing a certain type of signals, within the first wireless communication system.

41. The method of claim 34, wherein the carrier-sensing threshold is a Clear Channel Assessment Threshold (CCAT).

42. The method of claim 34, wherein a first carrier-sensing threshold is assigned for use in the first wireless communication system, applicable for transmissions identified as originating from within the same service set as the carrier-sensing communication unit, and a second carrier-sensing threshold is assigned for use in the first wireless communication system, applicable for transmissions identified as originating from outside the service set of the carrier-sensing communication unit, wherein the second carrier-sensing threshold is aligned or changed to the second level.

43. The method of claim 34, wherein the step of determining whether a second wireless communication system of a second, different type or radio access technology is operating on the same channel of the shared wireless medium as the first wireless communication system includes identifying ongoing or recent transmissions in the second wireless communication system on the considered channel.

44. The method of claim 34, wherein the first wireless communication system is a Wireless Local Area Network (WLAN) system and the second wireless communication system is a cellular radio network operating in unlicensed spectrum.

45. The method of claim 44, wherein the first wireless communication system is a Wi-Fi system.

46. The method of claim 44, wherein the second wireless communication system is based on License Assisted Access (LAA) or Long Term Evolution (LTE)-unlicensed.

47. The method of claim 34, wherein the method is performed by a communication unit of the first wireless communication system.

48. The method of claim 47, wherein the communication unit is an access point or a wireless communication device.

49. The method of claim 34, wherein an access point initiates the change of the carrier-sensing threshold by informing at least one associated wireless communication device that the carrier-sensing threshold should be changed from the first level to the second level.

50. The method of claim 34, wherein a wireless communication device identifies that the second wireless communication system is operating on the same channel as the first wireless communication system and initiates the change of the carrier-sensing threshold.

51. A network node configured to control access to a shared wireless medium in a first wireless communication system based on a contention-based protocol for medium access involving carrier sensing, wherein the first wireless communication system is of a first radio access technology, the network node comprising a processing circuit configured to:
determine whether a second wireless communication system of a second, different radio access technology is operating on the same channel of the shared wireless medium as the first wireless communication system; and
initiate, in response to determining that the second wireless communication system is operating on the same channel, a change of a carrier-sensing threshold used in the first wireless communication system for determining, for at least one communication unit, whether the medium is available for access, from a first level to a second, different level.

52. The network node of claim 51, wherein the carrier-sensing threshold is increased from a first lower level to a second higher level.

53. The network node of claim 51, wherein the carrier-sensing threshold is aligned to a so-called co-existence threshold level which differs from a default carrier-sensing threshold level used for signal detection within the first wireless communication system.

54. The network node of claim 53, wherein the default carrier-sensing threshold level is maintained for carrier-sensing applicable for transmissions originating from users within the same service set.

55. The network node of claim 53, wherein the co-existence level corresponds to the level of a threshold used in the second wireless communication system for determining whether the medium is available for access, or
wherein the co-existence level corresponds to the level used in the first wireless communication system for determining whether the medium is available for access when no carrier is detected, or
wherein the co-existence level corresponds to the level used in the first wireless communication system for energy detection.

56. The network node of claim 51, wherein the carrier-sensing threshold is a threshold for detection of signals within the first wireless communication system.

57. The network node of claim 51, wherein the first wireless communication system is a Wireless Local Area Network (WLAN) system and the second wireless communication system is a cellular radio network operating in unlicensed spectrum.

58. The network node of claim 57, wherein the first wireless communication system is a Wi-Fi system.

59. The network node of claim 57, wherein the second wireless communication system is based on License Assisted Access (LAA) or Long Term Evolution (LTE)-unlicensed.

60. The network node of claim 51, wherein the network node is an access point, radio network node or access controller.

61. A computer-readable medium comprising, stored thereupon, a computer program for controlling, when executed by at least one processor, access to a shared wireless medium in a first wireless communication system based on a contention-based protocol for medium access involving carrier sensing, wherein the first wireless communication system is of a first radio access technology,
wherein the computer program comprises instructions, which when executed, cause the at least one processor to:
determine whether a second wireless communication system of a second, different radio access technology is operating on the same channel of the shared wireless medium as the first wireless communication system; and
initiate, in response to determining that the second wireless communication system is operating on the same channel, a change of a carrier-sensing threshold used in the first wireless communication system for determining, for at least one communication unit, whether the medium is available for access from a first level to a second, different level.
